(19) United States
(12) Patent Application Publication
(10) Pub. No.: US 2026/0370672 A1
(43) Pub. Date: Nov. 19, 2026

(54) SYSTEM AND METHOD FOR ZERO-DAY ATTACK DETECTION BASED ON GPT INTEGRATION

(71) Applicant: Qubit Security Inc., Seongnam-si Gyeonggi-do (KR)

(72) Inventor: SeungMin SHIN, Suwon-si Gyeonggi-do (KR)

(73) Assignee: Qubit Security Inc., Seongnam-si Gyeonggi-do (KR)

(21) Appl. No.: 19/392,771

(22) Filed: Nov. 18, 2025

(30) Foreign Application Priority Data
May 13, 2025 (KR) 10-2025-0061993

(51) Int. Cl. H04L 9/40; H04L 41/16

(52) U.S. Cl. CPC H04L 63/1425; H04L 41/16

(57) ABSTRACT

The present invention relates to information security technology, and more particularly, to a system and method for performing comprehensive log analysis that automatically detects zero-day or newly modified attacks which cannot be identified by conventional rule- or signature-based detection, by integrating a large language model (LLM) such as GPT into log analysis. According to an embodiment of the invention, the GPT-integrated zero-day attack detection system and method can identify zero-day and variant attacks at an early stage by reanalyzing undetected logs from existing security systems through GPT-based semantic and contextual analysis and can continuously enhance detection accuracy and real-time responsiveness through automatic rule set optimization. In addition, the invention efficiently manages GPT usage costs and computational load through random and weighted sampling strategies while maintaining high detection performance, and prevents excessive responses caused by AI false positives through an administrator verification process.

### CROSS-REFERENCE TO RELATED APPLICATION

This application claims priority to Korean Patent Application No. 10-2025-0061993 filed on May 13, 2025, the entire contents of which are herein incorporated by reference.

### BACKGROUND

### 1.Technical Field

The present disclosure relates to the technical field of information security and, more particularly, to a log full‑review analysis system and method configured to automatically detect zero‑day or new variant attacks that cannot be identified by conventional rule‑ and signature‑based detection, by integrating a large language model (LLM), such as GPT, into log analysis.

### 2. Related Art

Conventional information‑security systems rely on rule‑, signature‑, and whitelist‑based, structured detection. Such approaches are effective for already‑known attack patterns but have limitations in coping with new vulnerabilities or modified attacks. In particular, zero‑day attacks or stealthy threats may lurk in the area of undetected logs that have been treated as 'normal' by security solutions, and technology for systematically re‑analyzing these logs is insufficient. Recently, large language models (LLMs), e.g., GPT, have shown strengths in meaning‑based analysis of unstructured data. By applying LLMs to security‑log analysis, attempts are being made to complement the limitations of rule‑based systems and to improve the accuracy and automation level of zero‑day attack detection.

Background art of the present disclosure is disclosed in Korea Patent Registration No. 10‑2353130.

### SUMMARY

The present disclosure is to provide a GPT‑integration‑based zero‑day attack detection system and method.

The present disclosure is to provide a semantic-based automatic analysis technology using a large language model such as GPT for undetected logs, as a solution to identify zero‑day and variant attacks that existing rule and signature-based security systems fail to detect.. Furthermore, the present disclosure seeks to establish a system capable of responding to new attacks in real-time while minimizing false positives by linking GPT analysis results with administrator verification procedures. A further objective is to introduce random and weighted sampling to alleviate cost and performance burdens arising from GPT API use and to establish a priority‑analysis scheme for logs from IP addresses with an attack history, thereby ensuring both efficiency and detection precision.

The technical problems that the present invention seeks to solve are not limited to those described above; other technical problems not expressly mentioned will be readily apparent to those of ordinary skill in the art from the following description.

According to one aspect of the present invention, a GPT‑integration‑based zero‑day attack detection system and method are provided.

In an embodiment of the present invention, the system may include a log processing unit that stores logs collected from multiple servers in a structured format; a first analysis unit that determines, by a conventional rule‑based engine, whether an attack is occurring; a second analysis unit that inputs a randomly or weighted‑sampled subset of undetected logs into a GPT‑based natural language processing engine and performs analysis; a log verification unit that finally verifies logs classified as suspicious by GPT; and an automatic response unit that immediately performs security measures for targets finally determined to be attacks based on the verification result. A method including corresponding steps may also be provided.

A GPT-integrated zero-day attack detection method may include: storing logs collected from a plurality of servers in a structured format; performing an initial determination, via an existing rule-based engine, as to whether the stored logs indicate an attack; randomly or with weighted sampling selecting a subset of logs that were not detected as attacks in the foregoing determination and inputting the subset to a GPT-based natural language processing engine for analysis; performing final verification on the logs that, based on the analysis, GPT classified as suspicious; and, based on the verification results, immediately taking security measures for targets ultimately determined to constitute attacks.

According to an embodiment of the present invention, the system and method can identify zero‑day and variant attacks early by re‑examining undetected logs through GPT‑based semantic and contextual analysis and can continuously improve detection accuracy and real‑time responsiveness through automatic supplementation of rule sets. Random and weighted sampling manage the cost and computational load of GPT use while maintaining high detection efficacy, and an administrator verification procedure prevents over‑response caused by AI false positives. In addition, a staged automation structure based on a GPT confidence score provides scalability and flexibility to evolve into a fully automated response system in the future.

The effects of the present invention are not limited to the foregoing, and should be understood to include any and all effects that may be inferred from the embodiments and configurations disclosed in the specification and the claims.

### BRIEF DESCRIPTION OF THE DRAWINGS

Various embodiments of the present disclosure will become more apparent in view of the attached drawings and accompanying detailed description, in which:

FIG. 1 is a configuration diagram of a GPT‑integration‑based zero‑day attack detection system according to an embodiment of the present invention.

FIG. 2 is a configuration diagram of a log collection unit of the GPT‑integration‑based zero‑day attack detection system according to an embodiment of the present invention.

FIG. 3 is a flowchart of a log‑analysis method of the GPT‑integration‑based zero‑day attack detection system according to an embodiment of the present invention.

FIG. 4 is an overall flowchart of the GPT‑integration‑based zero‑day attack detection method according to an embodiment of the present invention.

FIG. 5 is a flowchart of the GPT‑integration‑based zero‑day attack detection method according to an embodiment of the present invention.

FIG. 6 is a flowchart of the GPT‑integration‑based zero‑day attack detection method according to another embodiment of the present invention.

### DETAILED DESCRIPTION OF THE EMBODIMENTS

The invention may be modified in various ways and may have various embodiments; specific embodiments are illustrated in the drawings and will be described in detail. However, the disclosure is not intended to be limited to particular embodiments, and includes all changes, equivalents, and substitutions that fall within the spirit and scope of the invention. In describing the disclosure, detailed descriptions of related known technology may be omitted when it is determined that they may unnecessarily obscure the gist of the disclosure. Unless specifically stated otherwise, singular forms in the specification and claims may be interpreted as including plural forms. For example, GPT is a type of large language model (LLM), and analysis by GPT is not limited to GPT but extends to all AI capable of analyzing log data.

Throughout the specification, when a part is said to be 'connected (coupled, contacted, joined)' to another part, this includes both direct and indirect connections. The terms 'comprise' or 'have' specify the presence of features, numbers, steps, operations, components, or combinations thereof described in the specification, and do not preclude the presence or addition of one or more other features, numbers, steps, operations, components, or combinations thereof, unless there is a specially contrary description.

The terminology used in this specification is employed merely to describe particular embodiments and is not intended to limit the invention. Unless the context clearly indicates otherwise, singular expressions include the plural. As used herein, terms such as “include” or “have” are intended to designate the presence of the features, numbers, steps, operations, components, parts, or combinations thereof described in the specification, and should not be construed as excluding the possibility of the presence or addition of one or more other features, numbers, steps, operations, components, parts, or combinations thereof.

The present invention will be described below with reference to the accompanying drawings. However, the present invention may be implemented in various different forms and is not limited to the embodiments described herein. In the drawings, portions not related to the description have been omitted in order to clearly illustrate the invention, and like reference numerals are assigned to like parts throughout the specification.

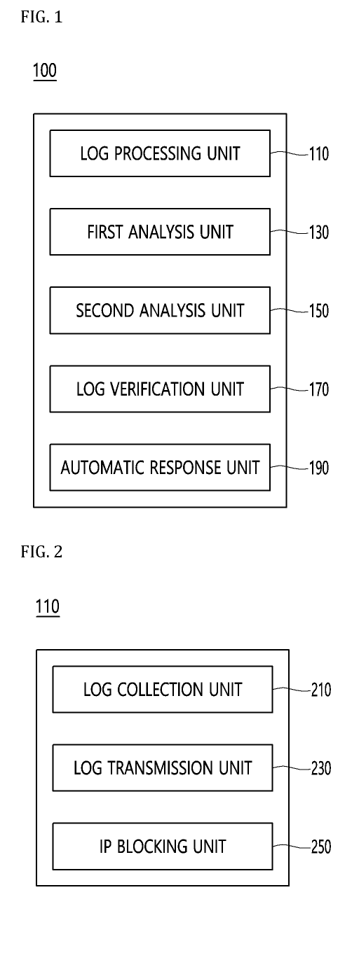

FIGS. 1 and 2 are diagrams showing configurations of a GPT-integrated zero-day attack detection system according to one embodiment of the present invention. In the following description, GPT is used as an example; however, the invention is not limited thereto, and various other large language models (LLMs) may be employed in the present invention.

Referring to FIG. 1, a GPT‑integration‑based zero‑day attack detection system 100 includes a log processing unit 110, a first analysis unit 130, a second analysis unit 150, a log verification unit 170, and an automatic response unit 190. The system 100 may include a processor and a memory storing program modules. The log processing unit 110, the first analysis unit 130, the second analysis unit 150, the log verification unit 170, and the automatic response unit 190 may be parts of the processor or the program modules to be executed by the processor.

The log processing unit 110 stores, in a structured format, logs collected from multiple servers. Specifically, collected logs include fields such as IP address, account name, request URI, User‑Agent, and event timestamps, and these fields are stored in a structured format. The log processing unit 110 masks or removes information including IP addresses and account names that correspond to personal information and then stores the data in a structured format to prevent leakage of personal information during GPT analysis.

The first analysis unit 130 determines, by a conventional rule‑based engine, whether an attack is occurring based on the collected logs. In particular, the first analysis unit 130 applies a rule‑based detection engine such as threshold‑based analysis, signature matching, and whitelist filtering through a correlation analysis module to make a first determination. Logs determined to be attacks interoperate with an automatic response module to immediately perform responses such as IP blocking and session termination. Undetected logs (i.e., logs not determined to be attacks; hereinafter 'undetected logs') are stored in a separate database.

The second analysis unit 150 inputs and analyzes, in a GPT‑based natural language processing engine, a subset of the undetected logs randomly or with weighting (e.g., 100 cases per hour). The second analysis unit 150 may extract, at a set cycle (e.g., every 10 minutes, every hour, every 12 hours), N cases (e.g., 100 per hour) from the undetected logs. The second analysis unit 150 dynamically adjusts the number of samples according to the total amount of logs to balance GPT API cost and analysis quality. In addition, the second analysis unit 150 assigns a weight to logs from IP addresses with a past attack history, preferentially sampling them to input logs with a higher likelihood of zero‑day attacks to GPT. The GPT engine analyzes the context and semantic features of the logs and classifies them into grades such as 'suspected new attack,' 'normal,' and 'needs additional verification,' and outputs the grounds for suspicion (e.g., rare request headers, rare overseas IP, abnormal User‑Agent). Personal‑information fields (IP address, account name, etc.) must be masked before being sent to the GPT engine.

A log verification unit 170 finally verifies logs that GPT has classified as suspicious. Specifically, for logs classified as 'suspected new attack' in the GPT analysis result, the log verification unit 170 performs final verification based on human intelligence. The log verification unit 170 determines whether an actual attack occurred by referencing existing attack history, external threat intelligence, and related‑log lookups. If it is determined to be a new type of attack, the information is reflected in the rule set of the correlation analysis module so that blacklist entries or whitelist exceptions are updated in real time, enabling automatic response to subsequent similar attacks.

An automatic response unit 190 determines whether to automatically block based on a malicious‑determination confidence score provided by the GPT model, performs automatic response when the score is equal to or greater than a set threshold, and otherwise waits for administrator approval. For example, when the confidence score is 95% or more, the automatic response unit 190 blocks immediately without approval, whereas when the confidence score is less than 90%, the automatic response unit 190 places the case on a waiting queue. Based on the verification results, the automatic response unit 190 immediately performs security measures such as IP blocking, forced session termination, account lock, and multi‑factor authentication (MFA) prompts. When an event suspected to be a zero‑day attack is detected, an alert is sent to an administrator and the defense posture is reinforced in real time through linkage with rule‑set updates.

For example, when a log is classified as 'attack suspected' on the grounds of an abnormal User‑Agent pattern but is verified to be a normal API request used by an in‑house R&D system for automatic calls, the automatic response unit 190 finally classifies the log as normal and adds a whitelist exception rule so that logs of the same type are not repeatedly detected. Conversely, if a log not detected by an OWASP signature‑based detection engine is classified as suspicious by the GPT analysis module on the grounds of a 'rare overseas IP + vulnerable URI' combination and is verified as an actual attack attempt, an administrator registers the related IP in a blacklist and the rule set of the correlation analysis module is updated to block, in real time, subsequent accesses of the same type.

Referring to FIG. 2, the log processing unit 110 includes a log collection unit 210, a log transmission unit 230, and an IP blocking unit 250.

The log collection unit 210 aggregates logs of various servers and services. The log collection unit 210 collects various types of log data generated from Linux servers, Windows servers, web servers, authentication servers, and the like in real time or batch form.

The log transmission unit 230 transmits the collected logs to a correlation analysis module to perform a first-stage attack analysis. The log transmission unit 230 also sends logs—including key fields such as masked IP addresses, URIs, HTTP methods, and User-Agent values—to the GPT. At this time, the transmitted data includes a prompt such as “Determine whether this log event is suspected to be an attack and describe the reason.” The log transmission unit 230 manages, in an accumulated manner, the number of detected attack logs and undetected (missed) logs per IP through the correlation analysis module. For example, if a specific IP address (e.g., 1.2.3.4) generates five attack-detected logs and one hundred undetected logs, this may be interpreted as an abnormal indication with a normal-to-attack ratio of 20:1. Such an IP is considered a high-risk entity and is given priority when sampling undetected logs in future analyses.

The IP blocking unit 250 immediately blocks an IP when the analysis result indicates an attack. The IP blocking unit 250 continuously monitors log traffic from IPs with a history of prior attacks and can automatically trigger GPT analysis if a predefined threshold is exceeded. For example, suppose a particular IP is judged as an attack by 9 out of 10 rules in an OWASP rule set. If the remaining one event was undetected and, within one hour, an additional 15 undetected logs are received from that IP, the automatic response unit 190 recognizes this as an anomalous condition and forwards the batch of logs to GPT analysis. If GPT classifies the logs as “suspicious,” the automatic response unit 190 performs verification and then executes IP blocking and updates the rule set.

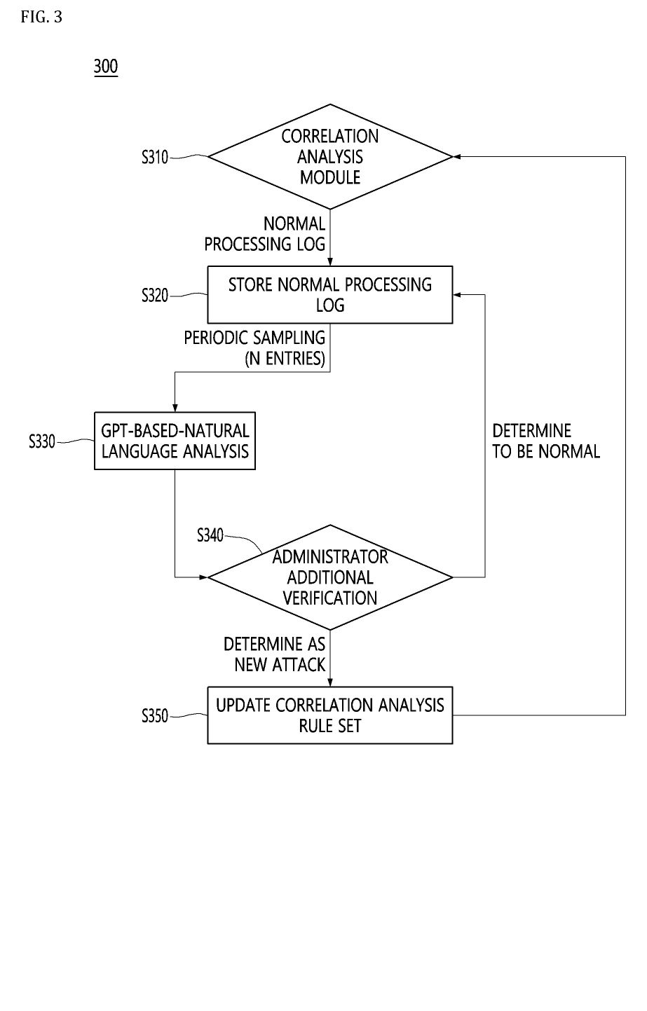

FIG. 3 is a flowchart of the log analysis method of the GPT-integrated zero-day attack detection system according to one embodiment of the present invention.

Referring to FIG. 3, in step S310, the GPT-integrated zero-day attack detection system transmits logs classified as normal by the correlation analysis module to normal‑processing logs.

In step S320, the GPT-integrated zero-day attack detection system stores the normal processing logs and periodically samples a predetermined number (N) of logs deliver to the GPT natural‑language analysis module.

In step S330, the GPT-integrated zero-day attack detection system performs natural language analysis based on the GPT engine.

In step S340, when the GPT analysis result is suspicious or requires additional confirmation, the GPT-integrated zero-day attack detection system performs additional verification by an administrator.

In step S350, if the corresponding log is determined to be a new attack, the GPT-integrated zero-day attack detection system immediately updates the correlation analysis rule set.

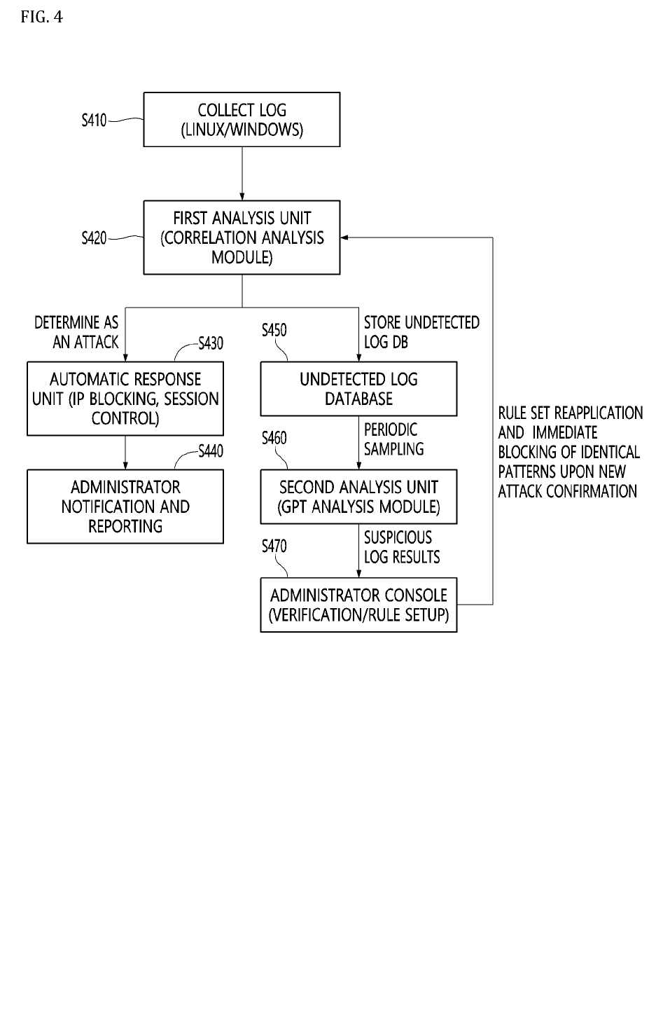

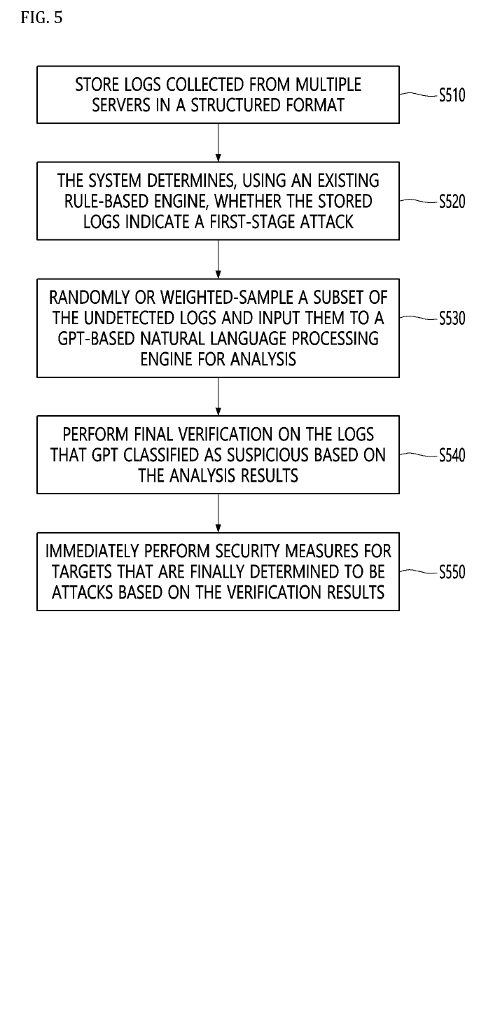

FIG. 4 is a flowchart illustrating the overall procedure of the GPT-integrated zero-day attack detection system according to one embodiment of the present invention.

Referring to FIG. 4, in step S410, the log collection unit of the GPT-integrated zero-day attack detection system collects log data from Linux or Windows servers.

In step S420, the first analysis unit (i.e. correlation analysis module) of the GPT-integrated zero-day attack detection system analyzes the logs and determines whether an attack occurred.

In step S430, The GPT-integrated zero-day attack detection system immediately responds to logs determined as attacks through the automatic response unit by performing IP blocking and session termination, and the like.

In step S440, the GPT-integrated zero-day attack detection system delivers warnings and reports to the administrator.

In step S450, the GPT-integrated zero-day attack detection system stores undetected logs in a separate database.

In step S460, the GPT-integrated zero-day attack detection system periodically delivers sampled logs to the GPT‑based natural‑language analysis module, which is the second analysis unit.

In step S470, When the GPT-integrated zero-day attack detection system classifies the GPT analysis result as a suspicious log, it verifies this through the administrator console, and if confirmed as an actual attack, the corresponding pattern is reflected in the rule set to perform automatic immediate blocking for the same type of pattern.

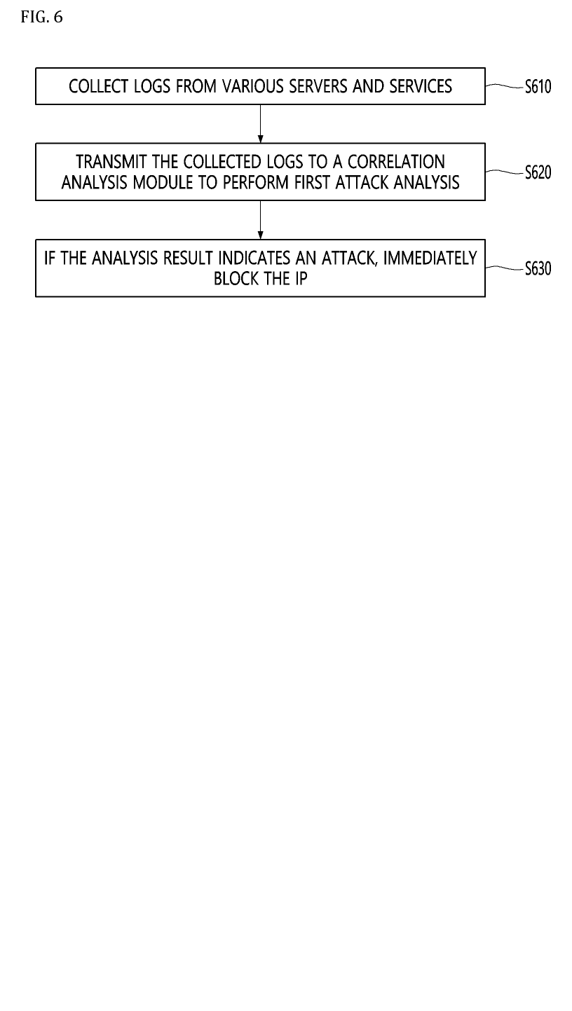

FIGS. 5 and 6 are flowcharts of the GPT-integrated zero-day attack detection system according to one embodiment of the present invention.

In step S510, the GPT-integrated zero-day attack detection system stores logs collected from a plurality of servers in a structured format. At this time, the system masks or removes information corresponding to personal data—such as IP addresses, account names, passwords, resident registration numbers, and card numbers—from the collected logs before structuring and storing them, thereby preventing the leakage of personal information during the GPT analysis process.

In step S520, the GPT-integrated zero-day attack detection system determines, using a conventional rule-based engine, whether the stored logs indicate a first-stage attack.

In step S530, the GPT-integrated zero-day attack detection system randomly or weight-sample selects a subset of the undetected logs and inputs them to a GPT-based natural language processing engine for analysis. The system assigns higher sampling weights to logs originating from IP addresses with prior attack history and prioritizes those logs, thereby delivering to GPT the logs that have a higher likelihood of representing zero-day attacks.

In step S540, the GPT-integrated zero-day attack detection system performs final verification on the logs that GPT classified as suspicious based on the analysis results.

In step S550, the GPT-integrated zero-day attack detection system immediately performs security measures for targets that are finally determined to be attacks based on the verification results. Specifically, the system determines whether to execute automatic blocking based on the confidence score of malicious determination provided by the GPT model. If the score exceeds a predefined threshold, automatic response is carried out; if it falls below the threshold, the system awaits administrator approval.

Referring to FIG. 6, in step S610, the GPT-integrated zero-day attack detection system aggregates logs from various servers and services.

In step S620, the system transmits the collected logs to a correlation analysis module to perform a first-stage attack analysis.

In step S630, if the analysis result indicates an attack, the GPT-integrated zero-day attack detection system immediately blocks the corresponding IP.

The GPT-integrated zero-day attack detection system and method described above may be implemented as code recorded on a computer‑readable medium. The computer‑readable recording medium may be a removable recording medium such as a CD, DVD, Blu‑ray disc, USB storage device, or removable hard disk, or a fixed recording medium such as ROM, RAM, or a computer‑installed hard disk. The computer program recorded on the computer‑readable recording medium may be transmitted to another computing device via a network such as the Internet and installed to be used there.

Although all components constituting the embodiments described above have been described as being combined or operating together, the disclosure is not necessarily limited thereto; within the scope of the object of the invention, all components may be selectively combined one or more and operate.

Although actions are shown in a particular order in the drawings, the invention should not be understood as requiring execution in the illustrated order or a sequential order, or that all illustrated actions must be executed to obtain desired results; multitasking or parallel processing may be advantageous in certain circumstances. Furthermore, separation of the various configurations described in the embodiments above should not be understood as strictly necessary; program components and systems may generally be integrated together as a single software product or packaged as multiple software products.

The invention has been described with reference to embodiments. One of ordinary skill in the art will appreciate that the invention may be implemented in a modified form without departing from its essential characteristics. Accordingly, the disclosed embodiments should be considered in a descriptive rather than limiting sense. The scope of the invention is shown in the claims, and all differences within an equivalent scope are to be construed as being included in the invention.

### Reference numerals

100 system

110 log processing unit

130 first analysis unit

150 second analysis unit

170 log verification unit

190 automatic response unit

210 log collection unit

230 log transmission unit

250 IP blocking unit

What is claimed is:

1. An LLM‑integration‑based zero‑day attack detection system, comprising:
a log processing unit configured to store, in a structured format, logs collected from multiple servers;
a first analysis unit configured to determine, through a conventional rule‑based engine, whether an attack is occurring for the stored logs;
a second analysis unit configured to randomly or weightedly samples a portion of undetected logs determined by the first analysis, inputs them into an LLM-based natural language processing engine, and analyzes them;
a log verification unit configured to finally verify logs classified as suspicious by an LLM model; and
an automatic response unit configured to, based on a verification result, immediately perform security measures for targets finally determined to be attacks.

2. The system of claim 1, wherein the log processing unit comprises:
a log collection unit configured to collect logs of various servers and services;
a log transmission unit configured to transmit the collected logs to a correlation analysis module to perform a first attack analysis; and
an IP blocking unit configured to, when a result of the first attack analysis indicates an attack, immediately block an IP address.

3. The system of claim 1, wherein the log processing unit is configured to mask or remove information including an IP address, an account name, a resident registration number, and a card number, which correspond to personal information, and to store it in a structured format so as to prevent leakage of personal information during LLM analysis.

4. The system of claim 1, wherein the second analysis unit assigns a weight to logs generated from an IP address with a history of past attacks among the undetected logs to prioritize sampling, thereby delivering logs with a high likelihood of zero‑day attacks to the LLM.

5. The system of claim 1, wherein the log verification unit determines whether an actual attack occurred by referencing information including existing attack history, external threat intelligence, and related‑log lookups.

6. An LLM‑integration‑based zero‑day attack detection method, comprising:
storing, in a structured format, logs collected from multiple servers;
determining, through a conventional rule‑based engine, whether an attack is occurring for the stored logs;
randomly or weightedly sampling a portion of undetected logs determined by first analysis, inputting them into an LLM-based natural language processing engine, and analyzing them;
finally verifying logs classified as suspicious by an LLM model; and

7. The method of claim 6, wherein determining, through a conventional rule‑based engine, whether an attack is occurring for the stored logs comprises:
a correlation analysis module to perform a first attack analysis; and
when a result of the first attack analysis indicates an attack, immediately blocking an IP address.

8. The method of claim 6, wherein determining, through a conventional rule‑based engine, whether an attack is occurring for the stored logs comprises; masking or removing, from the collected logs, information including an IP address, an account name, and a password, which correspond to personal information, and storing it in a structured format so as to prevent leakage of personal information during LLM analysis.

9. The method of claim 6, wherein randomly or weightedly sampling a portion of undetected logs determined by the first analysis, inputting them into an LLM-based natural language processing engine, and analyzing them comprises assigning a weight to logs generated from an IP address with a history of past attacks among the undetected logs to prioritize sampling, thereby delivering logs with a high likelihood of zero‑day attacks to the LLM.

10. The method of claim 6, wherein finally verifying the logs classified as suspicious by the LLM model comprises determining whether an actual attack occurred by referencing information including existing attack history, external threat intelligence, and related‑log lookups.

11. The method of claim 6, wherein randomly or weightedly sampling a portion of undetected logs determined by the first analysis, inputting them into an LLM-based natural language processing engine, and analyzing them comprises :
extracting N (where N is a natural number) undetected logs randomly at regular intervals;
dynamically adjusting number of samples according to a total amount of logs;
assigning a weight to logs that occurred from an IP address with a past attack history to preferentially sample the logs; and
delivering logs with a high likelihood of zero‑day attacks to a large language model (LLM),
analyzing contextual and semantic features of the logs through the LLM, classifying a grade for the log, and outputting grounds for suspicion.

12. A computer program recorded on a non-transitory computer‑readable recording medium, wherein execution of the program performs a zero‑day attack detection method based on integration of an LLM according to claim 6.
